(19) United States
(12) Patent Application Publication
(10) Pub. No.: US 2009/0180765 A1
(43) Pub. Date: Jul. 16, 2009

(54) Multiple-power-selection heat storage device

(76) Inventor: Ming-Hsiang Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,600

(22) Filed: Jan. 14, 2008

(51) Int. Cl. F24H 7/02; H05B 3/02

(52) U.S. Cl. 392/341; 219/482

(57) ABSTRACT

A multiple-power-selection heat storage device includes a power selection device, a heating device, and a storage tank. The power selection device includes a distribution selector and an uninterrupted power supply device. The distribution selector is arranged inside the uninterrupted power supply device and controls selection of power input of the power selection device among multiple power sources. The heating device is connected to the power selection device and includes a control unit and a heater controlled by the control unit. The storage tank is coupled to the heater of the heating device and the storage tank includes a container and a liquid contained in the container for purposes of heating. As such, the device of the present invention, as a whole, can be of multiple choices of power supply in supplying of warm air with a saving of energy.

### FIELD OF THE INVENTION

The present invention relates to a multiple-power-selection heat storage device, and in particular to a device comprising a combination of a power selection device, a heating device, and a storage device to feature multiple selections of power input and saving of energy, so as to be applicable to private and public places, such as home, office, and markets, to serve as air conditioning facility for heating.

### BACKGROUND OF THE INVENTION

Due to weather change caused by global warming, the variation of temperature all over the world is getting more and more significant. Consequently, the winter time becomes extremely cold, and the freezing low temperature often makes people constantly feeling cold in their extremities in the winter, their movement slow and their muscles bound. If warm keeping fails, causing hypothermia of human body, dangers, such as losing consciousness, losing discretion, and getting shock, may occur. Under this condition, a heater becomes vitally important, especially when the temperature difference between daytime and nighttime is significant, where people may get hypothermia in an unconscious and progressive manner. Apparently, the heater is a must for people to keep warm in the winter time.

Most of the currently available heaters of any kind, such as a heating/cooling air conditioning device, a ceramic heater, a halogen heater, an infrared heater, are powered by electricity from the electric main. This is certainly not economic, especially in the modern society that is getting short of energy supply, because heating facility is very power consuming and increases the utility expense. Apparently, the electric main is not an idea power source to suit the need of the future market.

With the change of the philosophy of power consumption, solar power generation is now a proposed substitution for energy supply, wherein every-sustained energy supply provided by the Nature is employed to generate electrical power. However, the application of the solar power generation is subjected to certain constraints. For example, the solar power generation only operates in daytime when there is sufficient sun light for converting the sun light into electrical power. In the nighttime when the indoor temperature rapidly drops, the heating facility is of even more importance and is put into operation more frequently. Thus, the limitation that the solar power generation can only be operated in the daytime is generally a serious problem for the application of the solar power generation.

In view of the above problems, the present invention is aimed to provide a multiple-power-selection heat storage device that overcomes the problems.

### SUMMARY OF THE INVENTION

An objective of the present invention is to provide a multiple-power-selection heat storage device, which features a combination of a power selection device, a heating device, and a storage tank, wherein the power selection device comprises a distribution selector, which functions to realize selection and distribution of input power at an input terminal from various power sources and supplying of the electrical power to activate the operation of the heating device for supplying heated warm air, whereby in the nighttime when no solar power generation is available for the power input, a liquid, which is contained in a container of the storage tank and which stores heat therein due to the operation of the heating device activated in the daytime, can maintain the supply of heated air without the supply of electrical power from any other secondary or backup power sources so as to enhance the practicability of the present invention.

Another objective of the present invention is to provide a multiple-power-selection heat storage device, which features a combination of a power selection device, a heating device, and a storage tank, wherein the storage tank is further connected to a circulation system that is comprised of multiple sets of associated air conduit and fan to distribute the heated air to various indoor rooms thereby enhancing the convenience of the present invention.

To realize the above objectives, in accordance with the present invention, a multiple-power-selection heat storage device is provided, comprising a power selection device, a heating device, and a storage tank. The power selection device comprises a distribution selector and an uninterrupted power supply device. The distribution selector is arranged inside the uninterrupted power supply device and controls selection of power input of the power selection device among multiple power sources. The heating device is connected to the power selection device and comprises a control unit and a heater controlled by the control unit. The storage tank is coupled to the heater of the heating device and the storage tank comprises a container and a liquid contained in the container for purposes of heating. As such, the device of the present invention, as a whole, can be of multiple choices of power supply in supplying of warm air with a saving of energy.

### BRIEF DESCRIPTION OF THE DRAWINGS

The present invention will be apparent to those skilled in the art by reading the following description of a preferred embodiment thereof with reference to the drawings, in which:

FIG. 1 is a schematic block diagram of a multiple-power-selection heat storage device constructed in accordance with the present invention;

FIG. 2 is a schematic block diagram illustrating an application of the multiple-power-selection heat storage device of the present invention;

FIG. 3 is a schematic view showing the connection of the multiple-power-selection heat storage device of the present invention with multiple power sources and a heating device; and

FIG. 4 is a schematic block diagram of a distribution selector of the multiple-power-selection heat storage device of the present invention.

### DETAILED DESCRIPTION OF THE PREFERRED EMBODIMENT

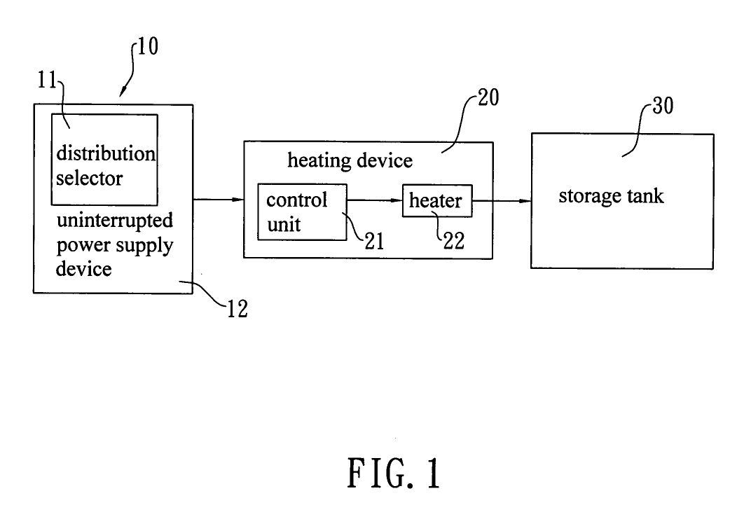

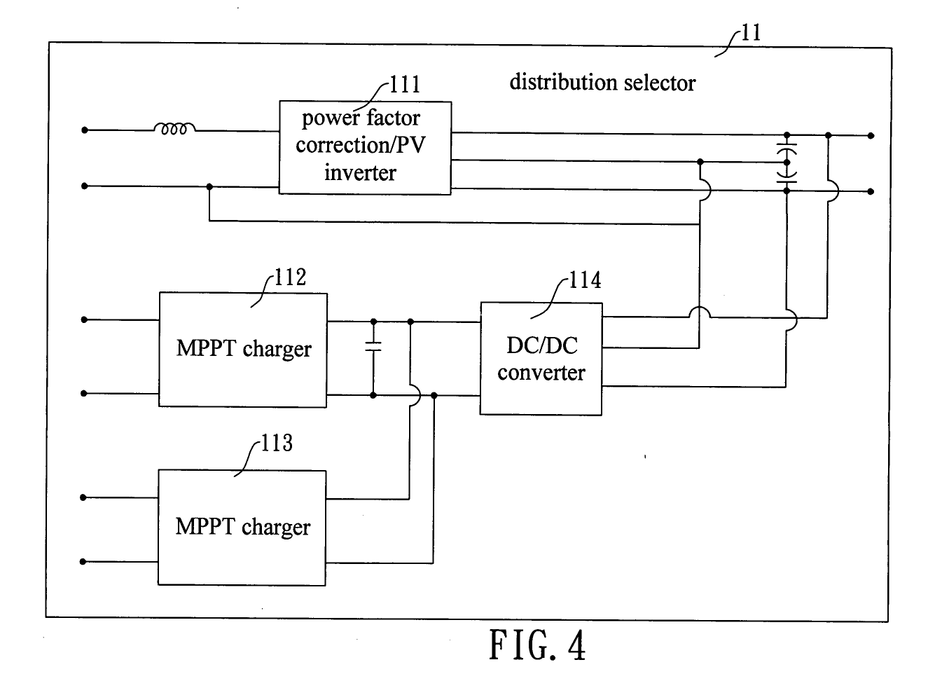

With reference to the drawings and in particular to FIGS. 1-4, the present invention provides a multiple-power-selection heat storage device comprising a power selection device 10, which comprises a distribution selector 11 and an uninterrupted power supply device 12. The distribution selector 11 is arranged inside the uninterrupted power supply device 12 and functions to selectively receive inputs of both direct-current (DC) power and alternate-current (AC) power, which can be at least one of a plurality of power sources including for example solar power generation 13, wind power generation 14, hydraulic power generation 15, and an electric main 16, for proper distribution of the input power supply among these power sources to realize diversification of supply of power. The distribution selector 11 is comprised of a plurality of capacitors, an inductor, a power factor correction/PV (photovoltaic) inverter 111, two MPPT (Maximum Power Point Tracking) chargers 112, 113, and a DC/DC converter 114. Each MPPT charger 112, 113 is connected to the DC/DC converter 114, which is connected in parallel to the power factor correction/PV inverter 111. The uninterrupted power supply device 12 comprises a charger 121 and a battery 122.

A heating device 20 is connected to the power selection device 10 and the heating device 20 comprises a control unit 21 and a heater 22. The control unit 21 controls the heating temperature of the heater 22 and detects overheating and realizes operation safety and protection. The heater 22 can carry out heating using a quartz resistance filament, infrared ceramics, electrical ceramic heater, or halogen lamp.

A storage tank 30 is connected to the heater 22 of the heating device 20. The storage tank 30 comprises a container and a liquid. The liquid can be either water or oil. The liquid is contained in the container.

The storage tank 30 is further coupled to a circulation system 40, which comprises at least one air conduit and one fan for distributing heated air to for example a living room 41, a bed room 42, a dinning room 43, a study room 44, and the likes.

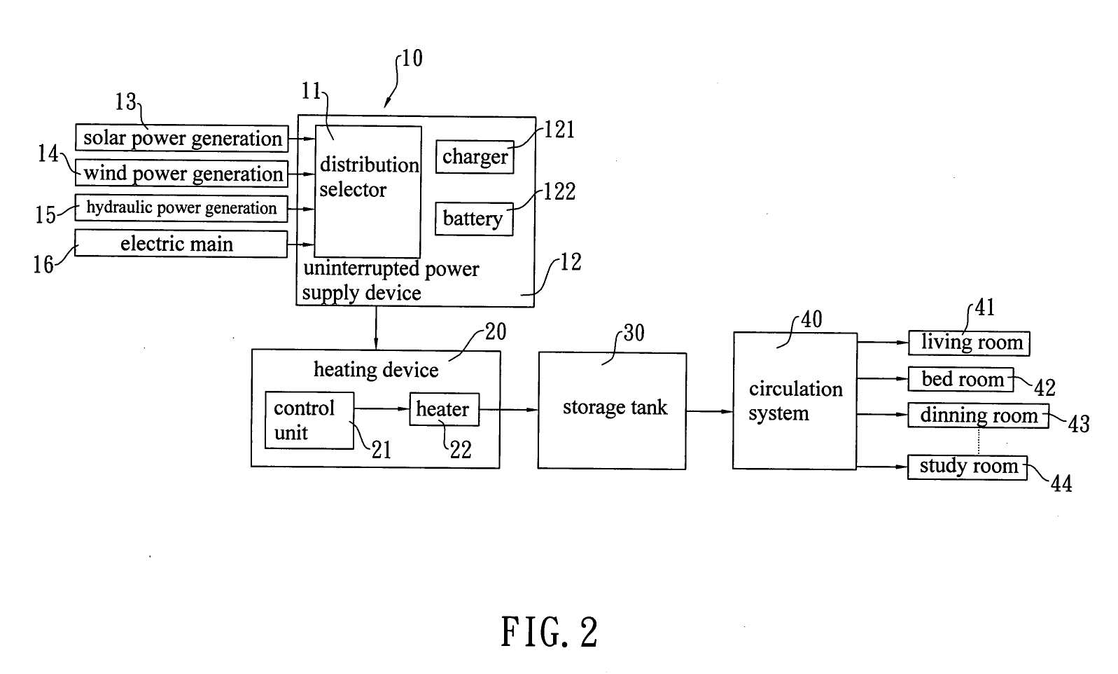

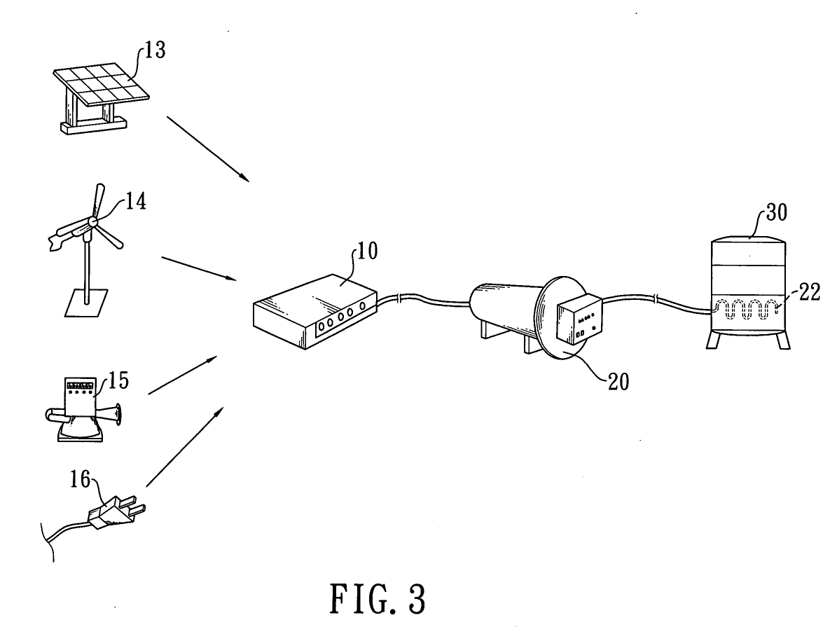

Referring to FIGS. 2 and 3, the instant embodiment provides a device that is composed of a combination of a power selection device 10, a heating device 20, and a storage tank 30, wherein the power selection device 10 comprises a distribution selector 11 and an uninterrupted power supply device 12 with the distribution selector 11 arranged inside the uninterrupted power supply device 12 and the distribution selector 11 functions to select a power input among solar power generation 13, wind power generation 14, hydraulic power generation 15, and an electric main 16, to realize distribution of supplying of power among these various power sources whereby for example in a sun shining day, the solar power generation 13 is taken as the power input of DC power to the heating device 20 and in a cloudy day or when there is insufficient sun light, other power sources are additionally adapted to supplemental power (of which an example includes a combination of 40% DC power supplied from solar power generation 13 and 60% power supplied from the wind power generation 16) or any other combination of the power sources is taken to directly supply power to the heating device 20, and as a consequence thereof, diversification of supplying of power is realized. The heating device 20 contains therein a control unit 21 and a heater 22 and the control unit 21 controls the heating temperature of the heater 22 and detects overheating and realizes operation safety and protection. The heater 22 adapts electrical ceramic heating but can alternatively be other heating means, such as quartz resistance filament, infrared ceramics, or halogen lamp. The heater 22 comprises piping extending in a circuitous way through the container of the storage tank 30 so that the heater 22 can heat the water (or oil) contained in the container. Thus, in the nighttime, when power supplied from the solar power generation 13 is shut down, the water contained in the container of the storage tank 30 that has been subjected to heating by heat exchange with the piping of the heater 22 of the heating device 20 in the daytime stores thermal energy or heat therein and such heat can be released to generate warm air without re-starting the heating process carried out by supplying electrical power from other secondary or backup power sources to the heating device 20. The storage tank 30 is further coupled to a circulation system 40, which comprises multiple sets of associated air conduit and fan for distributing the heated warm air to a living room 41, a bed room 42, a dinning room 43, a study room 44, and the likes.

Referring to FIGS. 1-4, the multiple-power-selection heat storage device of the present invention features a combination of a power selection device 10, a heating device 20, and a storage tank 30, wherein the power selection device 10 comprises a distribution selector 11 that selects at least one power input from solar power generation 13, wind power generation 14, hydraulic power generation 15, and electric main 16 for proper distribution of the input power among these power sources and directly supplies the power to the heating device 20. For example, a power input can be provided as a combination of 80% DC power provided by the solar power generation 13 and 20% AC power supplied from the electric main 16 for diversification of supplying of power, or can alternatively be any other distributed combination of any other power sources. Further, the distribution selector 11 may carry out control in such a way that when the heating device 20 is put into operation in the daytime, the power supplied from the solar power generation 13 is of the first priority to drive the operation of the heating device 20 for supplying warm air. The storage tank 30 is connected to the piping of the heater 22 of the heating device 20 so that the electrical power supplied from the solar power generation 13 in the daytime is employed to heat the liquid contained in the container of the storage tank 30 through the piping of the heater 22 to store heat in the liquid contained in the container of the storage tank 30.

In the nighttime when the solar power generation 13 stops to supply electrical power, the liquid contained in the container of the storage tank 30 that has stored therein heat due to heat exchange with the heater 22 of the heating device 20 in the daytime may release the heat stored therein for continuously supplying warm air without activating the heating device 20 by supplying power from other secondary or backup power sources.

Moreover, the storage tank 30 is further connected to the circulation system 40, which is comprised of multiple sets of associated air conduit and fan, to distribute and supply warm air to various indoor rooms, such as the living room 41, the bed room 42, the dinning room 43, and the study room 44.

Also, in case that the first priority power source of the solar power generation 13 does not work in bad weather or in an insufficient lighting surrounding, such as being at dust, the power selection device 10 selects the second priority power source, such as the wind power generation 14, the hydraulic power generation 15, or the other power generation systems to serve as a secondary or backup power supply. For example, there can be multiple simultaneous supplies of 30% DC power from the solar power generation 13, 20% power from the wind power generation 14, and 50% power from the electric main 16, which are, in total, 100% of power supply, or can alternatively be any other combinations of any other power sources, to realize diversified distribution of the power supply to various power sources. Consequently, the operation of the heating device 20 can be performed with reduced power supplied from the electrical main 16, so that the present invention, as a whole, can be of multiple choices of power supply in supplying of warm air with a saving of energy.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A multiple-power-selection heat storage device comprising:
a power selection device comprising a distribution selector and an uninterrupted power supply device, the distribution selector being arranged inside the uninterrupted power supply device and functioning to control selection of power input of the power selection device among multiple of power sources;
a heating device selection switch connected to the power selection device and comprising a control unit and a heater controlled by the control unit; and
a storage tank coupled to the heater of the heating device, the storage tank comprising a container and a liquid contained in the container for heating.

2. The multiple-power-selection heat storage device as claimed in claim 1, wherein the distribution selector selectively receives inputs of direct-current (DC) power and alternate-current (AC) power.

3. The multiple-power-selection heat storage device as claimed in claim 1, wherein the power input is obtained from various power sources comprising at least solar power generation, wind power generation, hydraulic power generation, and an electric main, of which at least one or a combination of more than one is selected as the power input to diversify supplying of power.

4. The multiple-power-selection heat storage device as claimed in claim 1, wherein the heater of the heating device comprises a heating element selected from a group consisting of quartz resistance filament, infrared ceramics, electrical ceramic heating, and halogen lamp,

5. The multiple-power-selection heat storage device as claimed in claim 1, wherein the liquid contained in the container of the storage tank is selected from a group consisting of water and oil.

6. The multiple-power-selection heat storage device as claimed in claim 1, wherein the storage tank is further coupled to a circulation system.

7. The multiple-power-selection heat storage device as claimed in claim 6, wherein the circulation system comprises at least one air conduit and one fan for distribution of heated air provided by the multiple-power-section heat storage device.

8. The multiple-power-selection heat storage device as claimed in claim 1, wherein the distribution selector comprises a power factor correction/PV (photovoltaic) inverter, at least one MPPT (Maximum Power Point Tracking) chargers, and a DC/DC converter, the MPPT charger being connected to the DC/DC converter, which is connected in parallel to the power factor correction/PV inverter.

9. The multiple-power-selection heat storage device as claimed in claim 1, wherein the uninterrupted power supply device comprises a charger and a battery.
